(19) United States
(12) Patent Application Publication
(10) Pub. No.: US 2026/0149215 A1
(43) Pub. Date: May 28, 2026

(54) RETENTION CAP FOR A CONNECTOR HOUSING, HOUSING ASSEMBLY, CONNECTOR AND CONNECTION ASSEMBLY

(71) Applicant: TE Connectivity Solutions GmbH, Schaffhausen (CH)

(72) Inventors: Jack BROWN, Hastings (GB); John PETTIFOR, Hastings (GB)

(21) Appl. No.: 19/392,436

(22) Filed: Nov. 18, 2025

(30) Foreign Application Priority Data
Nov. 22, 2024 (EP) 24214934.2

(51) Int. Cl. H01R 13/426; H01R 13/436

(52) U.S. Cl. CPC H01R 13/426; H01R 13/4364

(57) ABSTRACT

A retention cap for maintaining structural integrity of a connector including a housing and an internal component inserted into an opening of the housing, wherein the retention cap comprises an anchoring section for securing the retention cap to the housing around the opening; an abutment section for retaining the internal component inside the opening of the housing; and a through hole for passing at a wire to the at least one internal component along an insertion direction; wherein the anchoring section and the abutment section respectively extend around the through hole in a circumferential direction with respect to the insertion direction, and wherein the abutment section has a smaller inner circumference than the anchoring section. The abutment section can at least partly cover the opening of the housing to prevent the internal component from falling out, while the anchoring section with its larger inner circumference can cling onto the housing.

### CROSS REFERENCE TO RELATED APPLICATIONS

This application claims the benefit of EP Application No. 24214934.2, filed 22 Nov. 2024, the subject matter of which is herein incorporated by reference in its entirety.

### BACKGROUND OF THE INVENTION

The subject matter herein relates to a retention cap for a connector housing. Further, the subject matter herein relates to a housing assembly with such a retention cap and a connector housing. Moreover, the subject matter herein relates to a connector with such a housing assembly. Lastly, the subject matter herein relates to a connection assembly with such a connector and a mating connector.

In various technical fields, connectors are often used for establishing temporary or permanent connections when transmitting electrical currents, such as power and/or signals. The connectors can also have means for transmitting optical signals. Hence, the applicability of the subject matter herein extends to both electrical systems as well as optical, electro-optical and opto-electronical systems.

Depending on the application, the connectors comprise a number of functional components (e.g. contact elements, inserts, etc.). These functional components need to be securely held inside the connector, while also requiring a certain accessibility from outside the connector.

### BRIEF DESCRIPTION OF THE INVENTION

In an embodiment, it is an object to provide means for reliably holding connector components in place.

This object is achieved by a retention cap for maintaining structural integrity of a connector, the connector comprising a housing and at least one internal component inserted into an opening of the housing, wherein the retention cap comprises an anchoring section for securing the retention cap to the housing around the opening, an abutment section for retaining the at least one internal component inside the opening of the housing and a through hole for passing at least one cable or wire to the at least one internal component along an insertion direction, wherein the anchoring section and the abutment section respectively extend around the through hole in a circumferential direction with respect to the insertion direction, and wherein the abutment section has a smaller inner circumference than the anchoring section.

Herein, the inner circumference is the length of the inner perimeter or inner edge of the respective section measured along the circumferential direction. In other words, the inner circumference represents the boundary line between the respective section and the through hole in any given cross-section of the retention cap perpendicular to the insertion direction. The smaller the inner circumference, the narrower the through hole. Consequently, the through hole is narrower at the abutment section, than at the anchoring section.

By providing the abutment section with the smaller inner circumference, the abutment section can at least partly cover the opening of the housing around which the retention cap is secured. This prevents the at least one internal component inserted into the opening from falling out. The anchoring section with its larger inner circumference can cling onto the housing and correctly position the abutment section relative to the opening. All the while, the through hole allows the at least one internal component in the housing to be reached e.g. by cables and/or wires.

Hence, a solution, according to the subject matter herein, achieves the above object of reliably holding connector components in place. Without the retention cap being secured to the housing, the at least one internal component would be removable from the opening along the insertion direction, the same way as it was inserted into the opening along the insertion direction.

The above object is also achieved by a housing assembly comprising a retention cap according to the subject matter herein and a cap-compatible housing. Said housing comprises the above-mentioned opening and an attachment collar extending in the circumferential direction around the opening. The attachment collar is at least partly insertable into the through hole of the retention cap and the retention cap is configured to be secured to the attachment collar.

The housing assembly benefits from the advantages and functionality of the retention cap. In particular, the housing assembly can be readily used in a connector to securely hold the connector's internal components.

Moreover, a connector comprising a housing assembly according to the subject matter herein and at least one internal component inserted into the opening of the housing also achieves the above object. Herein, the retention cap is secured to the attachment collar of the housing, and the at least one internal component is retained inside the opening of the housing by the abutment section of the retention cap.

Lastly, the above object is achieved by a connection assembly comprising a connector according to the subject matter herein and a mating connector that is configured to be pluggable with the connector. Advantageously, the internal components of the connector are securely held due to the retention cap.

The invention can further be improved by the following embodiments which are advantageous in themselves and which can be arbitrarily combined with one another.

According to one possible embodiment, the abutment section may comprise a stop surface facing towards the anchoring section. In particular, the stop surface may be a flat, ring-shaped surface that is perpendicular to the insertion direction. When the retention cap is secured to the housing, the stop surface faces the opening. Hence, it is this stop surface of the abutment section that at least partly covers the opening of the housing and prevents the at least one internal component from falling out of the opening.

Optionally, the stop surface may at least partly be supported by the housing. For example, the attachment collar of the housing may comprise an end face on which the stop surface of the abutment section can rest flatly. Herein, the end face of the attachment collar may be located at a front or rear of the housing. Consequently, the retention cap can be secured to the front end or the rear end of the connector housing. At the front end, the through hole may form part of the connector's mating face. At the rear end, the through hole may serve as a passage for cables and/or wires as already described above.

In order to prevent the ingress of water or other types of contaminants into the opening of the housing, the housing assembly may comprise a seal element. The seal element may be configured to be at least partly arranged between the attachment collar of the housing and the abutment section of the retention cap. In that position, the seal element may also provide a damping effect which prevents relative movement between the retention cap and housing. Moreover, the seal element may serve for tolerance compensation.

For example, the seal element may comprise a skirt or a flange that extends in the circumferential direction radially outwards. This skirt or flange can be sandwiched and squeezed between the end face of the attachment collar and the stop surface of the abutment section.

To account for the lateral expansion of the squeezed seal element, the retention cap may comprise a radial groove extending in the circumferential direction between the anchoring section and the abutment section. The radial groove may be part of the through hole. In particular, the through hole may be widest at the radial groove. Hence, a displacement of the skirt or flange of the seal element can be accommodated in the radial groove when it is compressed and partially extruded from between the end face and the stop surface.

The anchoring section, in turn, may comprise a latch surface facing towards the abutment section. The latch surface may also be a flat, ring-shaped surface that is perpendicular to the insertion direction and parallel to the stop surface. As such, the latch surface may form an undercut that engages in a form-fit connection with the housing. In particular, the attachment collar of the housing may comprise an outwardly protruding bulge extending in the circumferential direction, wherein the anchoring section of the retention cap may be configured to be secured to said bulge. That is, when the attachment collar is inserted into the through hole, the latch surface may reach behind the bulge and result in the aforementioned form-fit connection.

In order to prevent the latch surface of the anchoring section from interfering with the end face of the attachment collar, the stop surface may extend further than the latch surface in a radial direction with respect to the insertion direction. In other words, the stop surface may extend further into the through hole than the latch surface. Thereby, the stop surface can rest on the end face of the attachment collar, while the latch surface avoids the end face of the attachment collar.

As an alternative to the aforementioned form-fit connection between the latch surface and bulge, the anchoring section may also be configured for a press fit or interference fit with the attachment collar.

Optionally, the anchoring section may comprise a lead-in chamfer extending in the circumferential direction and obliquely to the insertion direction. For example, the lead-in chamfer may form a tapered edge of the through hole that facilitates insertion of the attachment collar into the through hole.

The lead-in chamfer and the latch surface may be arranged adjacently and at an angle with respect to each other. In particular, the lead-in chamfer and the latch surface may be formed on a wedge-shaped protrusion that extends in the circumferential direction and projects inwardly into the through hole. Hence, the aforementioned form-fit connection between the retention cap and the housing may be implemented as a snap-fit connection. Compared to form-fit connections with threads and screws, the snap-fit connection is more vibration resistant, quicker to install and does not require any torque wrench.

Alternatively or additionally to the lead-in chamfer on the anchoring section, the bulge of the attachment collar may also comprise a tapered edge that facilitates the insertion of the attachment collar into the through hole.

The tapered edge of the bulge can also be used for centering purposes. That is, the anchoring section may comprise a centering surface extending in the circumferential direction and obliquely to the insertion direction. Moreover, the centering surface may be arranged between the latch surface and the stop surface. With respect to the insertion direction, the centering surface may have the same angle as the tapered edge. In other words, the centering surface may form an inside taper, while the tapered edge forms a complementary outer taper.

Once the attachment collar is inserted into the through hole and the latch surface snaps behind the bulge, the tapered edge of the bulge can be seated on the centering surface. Due to the respective taper shape, the retention cap is automatically centered relative to the attachment collar.

The centering surface may extend at a different angle than the lead-in chamfer. In particular, the lead-in chamfer may have an angle that is more acute than the angle of the centering surface. Hence, the tapered edge of the bulge can be prevented from getting wedged at the lead-in chamfer.

According to another possible embodiment, the anchoring section may extend in a circumferentially closed manner. Additionally or alternatively, the abutment section may extend in a circumferentially closed manner. That is, the anchoring section and/or abutment section may be continuous in the circumferential direction without any gaps or breaks in the material. This allows mechanical loads and stresses to be distributed onto the entire circumference of the respective section, resulting in an increased structural stability of the retention cap. Specifically for the circumferentially closed anchoring section, there is a lower risk of breakage compared to form-fit connections that utilize individual latching arms or other kinds of discontinuities.

Optionally, the anchoring section and the abutment section may be mutually coaxial with respect to the insertion direction. Moreover, the anchoring section and/or the abutment section may be substantially cylindrical. That is, the anchoring section and/or the abutment section may have a round profile. Thereby, corners and non-round geometries that would lead to stress peaks can be omitted. However, depending on the shape of the connector, the retention cap, in particular its anchoring section, may also have a rectangular, square, polygonal, oval or elliptical profile.

If the anchoring section has a round profile, the retention cap may comprise at least one keying feature that prevents the retention cap from freely rotating and rattling. In particular, the keying feature may extend in the through hole in the insertion direction. The housing, in turn, may comprise at least one complementary keying feature configured to be engaged with the at least one keying feature of the retention cap. The keying features may be pairs of key protrusions and key ways that are located at corresponding positions on the retention cap and housing, in particular on the anchoring section and the attachment collar.

According to another possible embodiment, a material thickness of the abutment section may be larger than a material thickness of the anchoring section. Hence, the anchoring section may be less rigid, which facilitates the attachment of the retention cap to the housing. Herein, the material thickness of the respective sections may be an average material thickness measured in a radial direction with respect to the insertion direction.

Optionally, the retention cap may comprise an intermediate section that connects the anchoring section and the abutment section. The intermediate section may extend around the through hole in the circumferential direction. Further, the intermediate section may have a smaller material thickness than the anchoring section and the abutment section. In particular, the above-mentioned radial groove may be formed by the intermediate section.

By adjusting the inner circumference of the abutment section, the anchoring section and the intermediate section through the respective material thicknesses, the abutment section, the anchoring section and the intermediate section may have the same outer circumference. Or if they do not have the same outer circumference, they have at least less difference in the outer circumference than in the inner circumference. This results in an even outer surface and improves the handling of the retention cap.

For more improved handling, the outer surface of the retention cap may be provided with a knurling. That is, the retention cap may comprise an outward facing knurled surface located on the anchoring section and/or the abutment section. If additional strain relief is required, a heat shrink tube can be placed around the cable and/or wires. Said heat shrink tube can then be shrunk onto the knurled surface.

In the connection assembly, not just the connector, but also the mating connector may comprise a housing assembly according to the subject matter herein. Thus, the mating connector benefits from the advantages and functionality of the subject matter herein by having a retention cap of its own.

According to another possible embodiment, the housing assembly may further comprise a coupling ring. For example, the coupling ring may be part of a bayonet-style mating aid mechanism that is shared with the mating connector. As such, the coupling ring may comprise at least one mating aid feature and the mating connector may comprise at least one complementary mating aid feature configured to be engaged with the at least one mating aid feature of the coupling ring.

The at least one mating aid feature may be a cam groove, while the at least one complementary mating aid feature may be a cam link that is guided in the cam groove when the coupling ring is manually rotated. Therefore, the coupling ring may be held movably, in particular rotatably to the housing. For this purpose, the housing of the housing assembly may comprise a shoulder adjacent to the attachment collar. When the retention cap is secured to the attachment collar, the coupling ring may be movably, in particular rotatably, held between the retention cap and the shoulder. Hence, the retention cap not only retains internal components of the connector, but also external components such as the coupling ring.

In the following, exemplary embodiments are described with reference to the figures. In the figures, the same reference numerals are used for elements that correspond to one another in terms of their function and/or structure. As described above, an aspect of an embodiment can be omitted if its technical effect is not needed for a particular application, and vice versa: an aspect that is not part of a specific embodiment may be added if its technical effect is advantageous in a specific application.

### BRIEF DESCRIPTION OF THE DRAWINGS

### In the Figures:

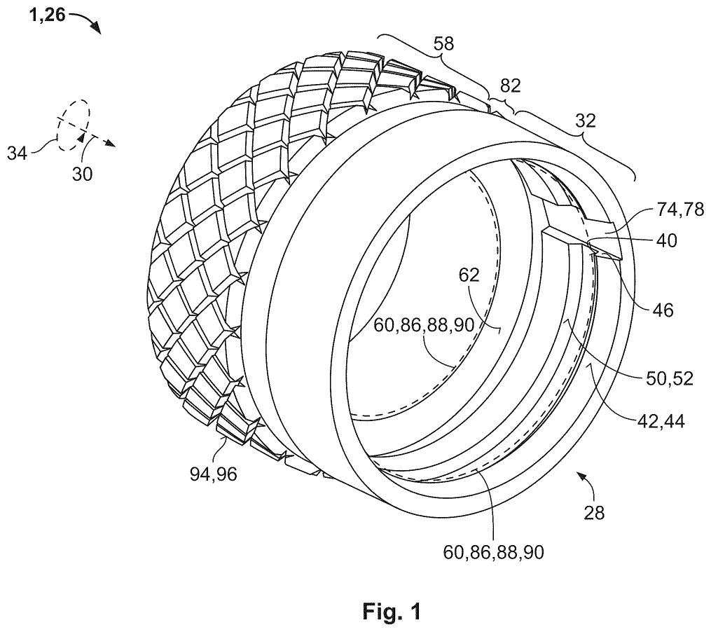

FIG. 1 shows a schematic perspective view of a retention cap according to a possible embodiment;

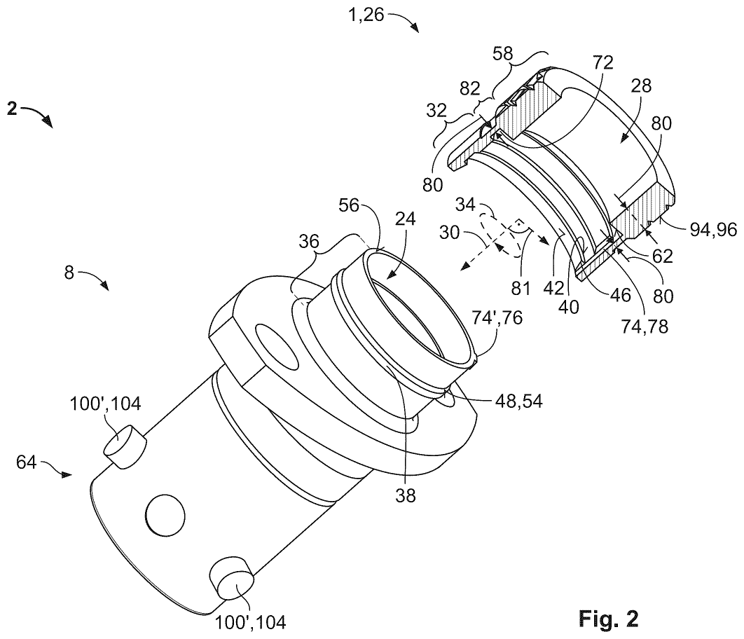

FIG. 2 shows a partial sectional view of a housing assembly according to a possible embodiment;

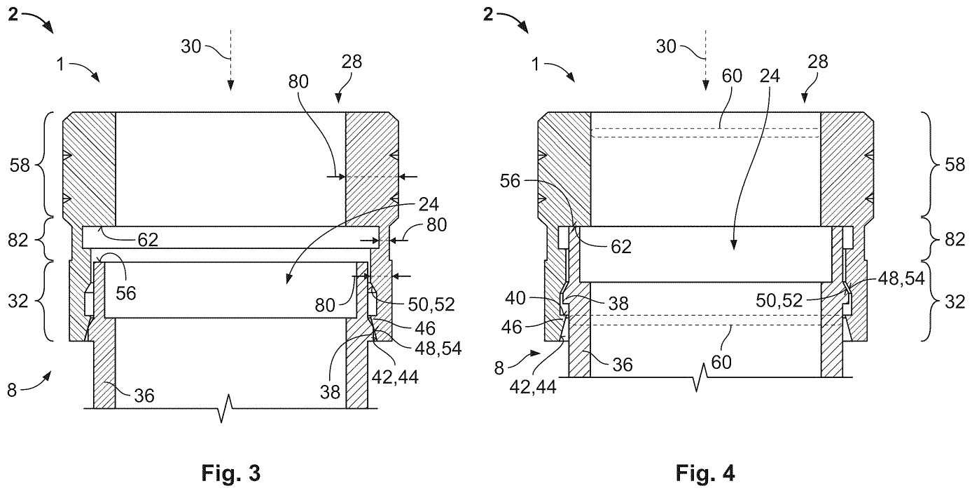

FIG. 3 shows a sectional side view of the housing assembly from FIG. 2;

FIG. 4 shows another sectional side view of the housing assembly from FIG. 2;

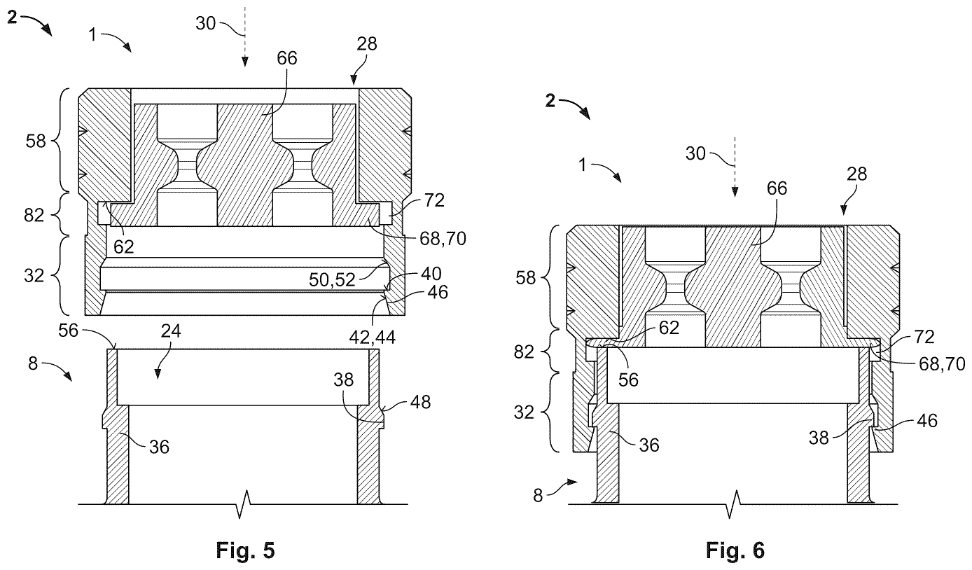

FIG. 5 shows a sectional side view of the housing assembly according to another possible embodiment;

FIG. 6 shows another sectional side view of the housing assembly from FIG. 5;

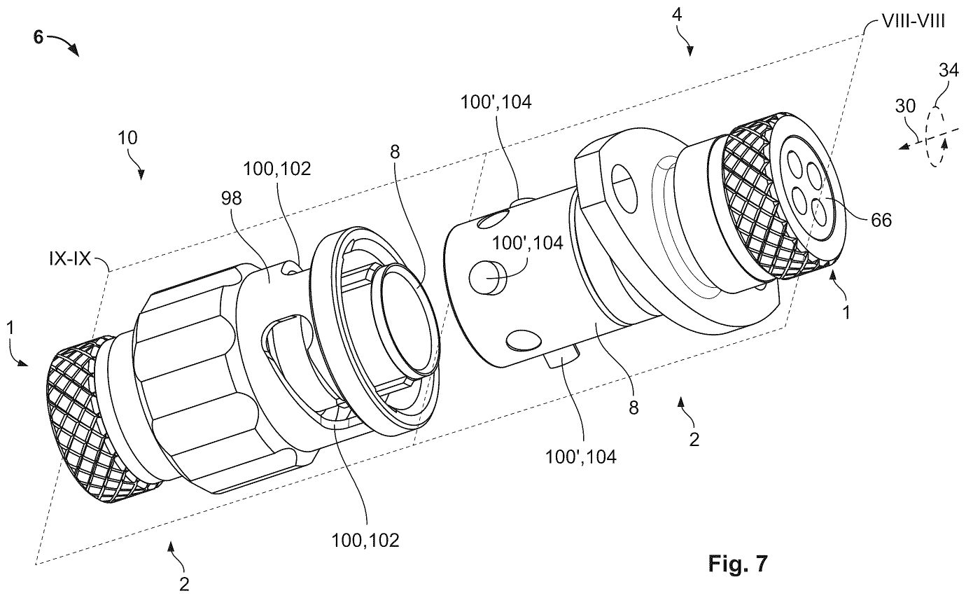

FIG. 7 shows a partially exploded, perspective view of a connection assembly according to a possible embodiment;

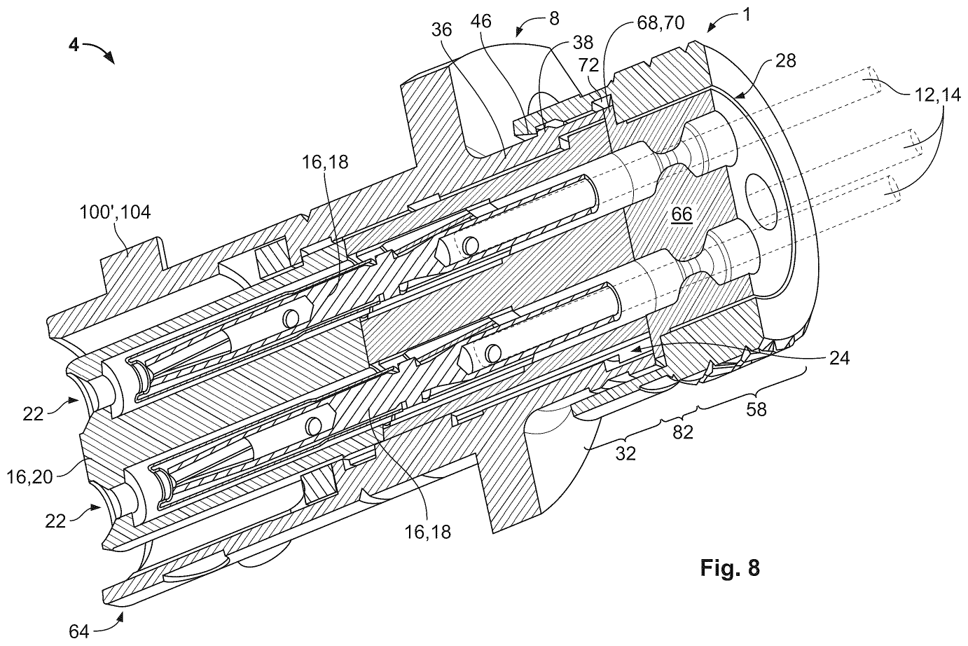

FIG. 8 shows a perspective, sectional view of a connector according to a possible embodiment cut along the plane VIII-VIII shown in FIG. 7;

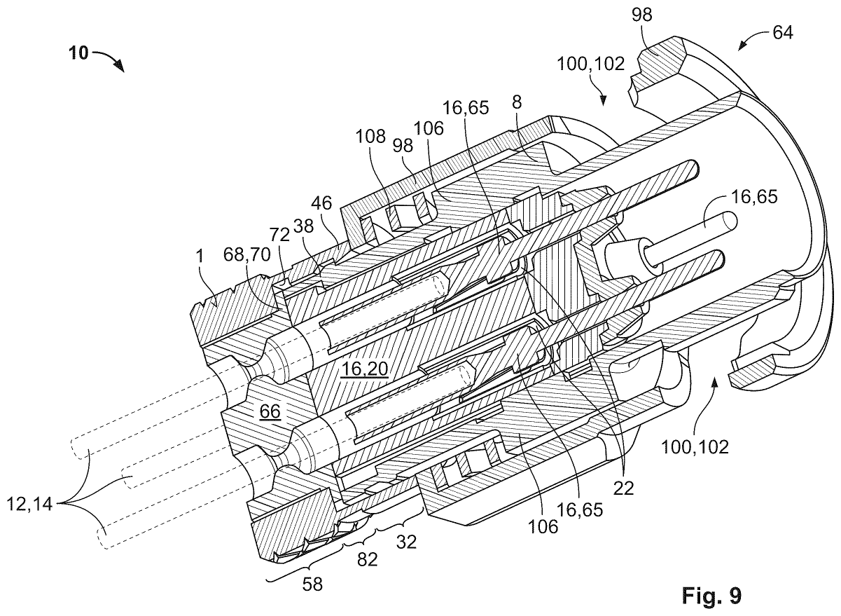

FIG. 9 shows a perspective, sectional view of a connector according to another possible embodiment cut along the plane IX-IX shown in FIG. 7;

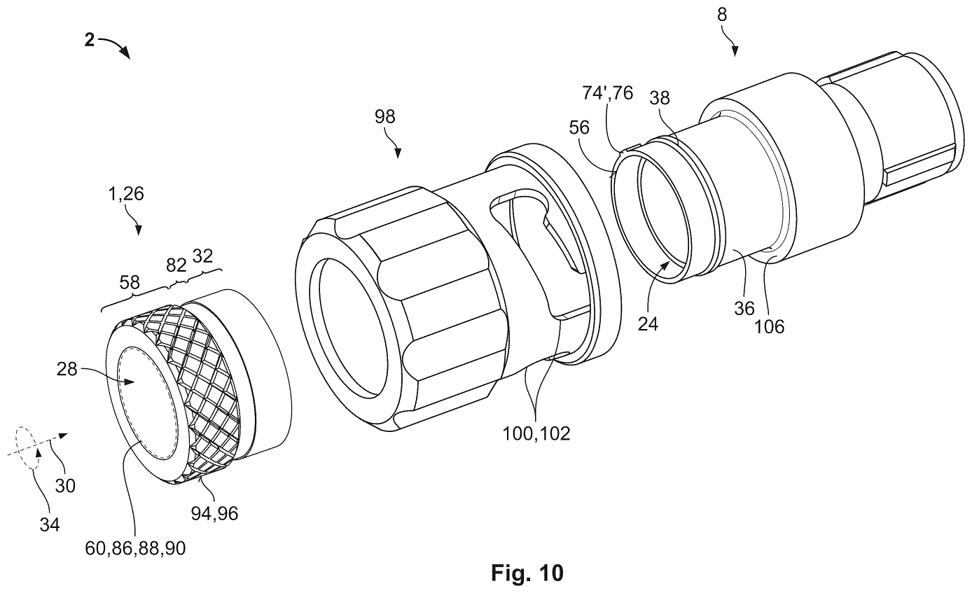

FIG. 10 shows an exploded, perspective view of the housing assembly according to another possible embodiment; and

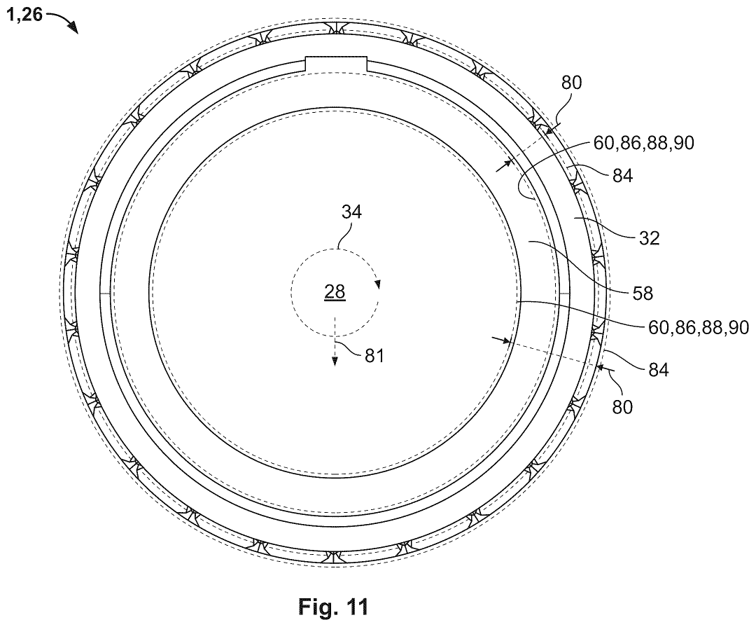

FIG. 11 shows a schematic front view of the retention cap from FIG. 1.

### DETAILED DESCRIPTION OF THE INVENTION

In the following, the schematic structure of a retention cap 1, a housing assembly 2, a connector 4 and a connection assembly 6 will be explained with reference to FIGS. 1 to 11. The retention cap 1 may be a part of the housing assembly 2, which further comprises a cap-compatible housing 8 (see FIG. 2). As such, the housing assembly 2 can be utilized for the connector 4. The connection assembly 6 may comprise the connector 4 and a mating connector 10 that is configured to be pluggable with the connector 4 (see FIG. 7). The mating connector 10 may also comprise the housing assembly 2 in a complementary design to the connector 4.

The connection assembly 6 may be used in an electrical system. However, the applicability of the present invention is not limited to electrical systems, and can also extend to optical, electro-optical and opto-electronical systems. As such, the connector 4 may comprise means for transmitting electrical power, electrical signals and/or optical signals, for example, cables 12 or wires 14 (see FIG. 8).

Further, the connector 4 may comprise internal components 16, such as contact elements 18 and inserts 20. In particular, multiple contact elements 18 may be held by one insert 20 as shown in FIG. 8. Each insert 20 comprises multiple contact chambers 22, in each of which one contact element 18 is accommodated. The insert 20 itself is accommodated in an opening 24 of the housing 8. The retention cap 1 serves to securely hold the insert 20 inside of the opening 24. By doing so, the retention cap 1 maintains the structural integrity of the whole connector 4.

As can be seen in FIG. 1, the retention cap 1 may be a single-piece component 26. For example, the retention cap 1 may be made from metal e.g., by casting, sintering, machining, lathing, deep drawing, embossing or stamping. Optionally, the retention cap 1 may be plated or coated. Alternatively, the retention cap 1 may be made from plastic by injection molding or additive manufacturing. It is also conceivable, as a further alternative, that the retention cap 1 comprises an inner metal shell for stability and is over-molded by plastic or another kind of insulation material.

In general, the retention cap 1 may have a ring shape spanning around a through hole 28. The through hole 28 may extend along an insertion direction 30 and may serve as a passage for the cables 12 or wires 14 of the connector 4. This allows the cables 12 or wires 14 to reach the internal components 16 located inside the opening 24.

The retention cap 1 comprises an anchoring section 32 that extends around the through hole 28 in a circumferential direction 34 with respect to the insertion direction 30. The anchoring section 32 secures the retention cap 1 around the opening 24 by clinging onto the housing 8 as is shown in FIGS. 3 and 4. In particular, the housing 8 comprises an attachment collar 36 extending in the circumferential direction 34 around the opening 24 (see FIG. 2). The attachment collar 36 is at least partly insertable into the through hole 28 of the retention cap 1.

Moreover, the attachment collar 36 and the anchoring section 32 may be configured to engage in a form-fit connection. For this purpose, the attachment collar 36 may comprise an outwardly protruding bulge 38 extending in the circumferential direction 34. The anchoring section 32, in turn, may comprise a latch surface 40 that forms an undercut for the bulge 38. In other words, the latch surface 40 may reach behind the bulge 38, when the attachment collar 36 is inserted into the through hole 28. This results in the aforementioned form-fit connection.

Optionally, the anchoring section 32 may comprise a lead-in chamfer 42 extending in the circumferential direction 34 and obliquely to the insertion direction 30. For example, the lead-in chamfer 42 may form a tapered edge 44 of the through hole 28 that facilitates insertion of the attachment collar 36 into the through hole 28.

The lead-in chamfer 42 and the latch surface 40 may be arranged adjacently and at an angle with respect to each other. In particular, the lead-in chamfer 42 and the latch surface 40 may be formed on a wedge-shaped protrusion 46 that extends in the circumferential direction 34 and projects inwardly into the through hole 28. Hence, the aforementioned form-fit connection may be implemented as a snap-fit connection that merely requires the retention cap 1 to be placed onto the attachment collar 36 as shown in FIG. 3. From there, the retention cap 1 is simply pressed in the insertion direction 30 until the latch surface 40 reaches behind the bulge 38 (see FIG. 4). Herein, the bulge 38 may also comprise a tapered edge 48 that facilitates the insertion of the attachment collar 36 into the through hole 28.

The tapered edge 48 of the bulge 38 can also be used for centering purposes. That is, the anchoring section 32 may comprise a centering surface 50 extending in the circumferential direction 34 and obliquely to the insertion direction 30. Moreover, the centering surface 50 may be arranged behind the latch surface 40 further inside the through hole 28. With respect to the insertion direction 30, the centering surface 50 may have the same angle as the tapered edge 48. In other words, the centering surface 50 may form an inside taper 52, while the tapered edge 48 forms a complementary outer taper 54.

Once the attachment collar 36 is inserted into the through hole 28 and the latch surface 40 snaps behind the bulge 38, the tapered edge 48 of the bulge 38 can be seated on the centering surface 50. Due to the respective taper shape, the retention cap 1 is automatically centered relative to the attachment collar 36 (see FIG. 4).

The centering surface 50 may extend at a different angle than the lead-in chamfer 42. In particular, the lead-in chamfer 42 may have an angle that is more acute with respect to the insertion direction 30 than the angle of the centering surface 50. Hence, the tapered edge 48 of the bulge 38 can be prevented from getting wedged at the lead-in chamfer 42 (see FIG. 3).

According to an alternative embodiment that is not shown in the figures, the anchoring section 32 may be configured for a press fit or interference fit with the attachment collar 36, instead of the aforementioned form-fit connection.

Once the retention cap 1 is secured to the housing 8, it may be supported by the housing 8. For this purpose, the attachment collar 36 may comprise an end face 56 against which the retention cap 1 can abut (see FIG. 4). In particular, the retention cap 1 comprises an abutment section 58 that extends around the through hole 28 in the circumferential direction 34 and has a smaller inner circumference 60 than the anchoring section 32. In other words, the abutment section 58 extends further into the through hole 28 than the anchoring section 32. Hence, the abutment section 58 can abut against the end face 56, while the anchoring section 32 avoids the end face 56.

As can be seen in FIG. 1, the abutment section 58 may comprise a stop surface 62 facing towards the anchoring section 32. In particular, the stop surface 62 may be a flat, ring-shaped surface that is perpendicular to the insertion direction 30. When the retention cap 1 is secured to the housing 8, the stop surface 62 faces the opening 24 and rests flatly on the end face 56.

Moreover, the stop surface 62 at least partly covers the opening 24 and thus prevents the internal components 16 from falling out of the opening 24. Hence, the abutment section 58 and its stop surface 62 serve the purpose of retaining the internal components 16 in place.

Similar to the stop surface 62, the latch surface 40 may also be a flat, ring-shaped surface that is perpendicular to the insertion direction 30. Herein, the latch surface 40 may face towards the abutment section 58 and may be parallel to the stop surface 62. However, the latch surface 40 does not extend as far as the stop surface 62 into the through hole 28, in order to avoid interfering with the end face 56.

In the embodiment of FIG. 2, the end face 56 of the attachment collar 36 is located at a rear of the housing 8. On the opposite side, at the front of the housing 8, a mating face 64 is formed. The opening 24 of the housing 8 opens out into the mating face 64. The internal components 16 are stacked into the opening 24 from the rear, wherein the contact elements 18 are positioned within the mating face 64 readily accessible for mating contacts 65 of the mating connector 10 (see FIG. 9). The retention cap 1 is secured to the rear of the housing 8 and retains the stacked internal components 16 in place.

Without the retention cap 1 secured to the housing 8, the stacked internal components 16 would be removable from the opening 24 along the insertion direction 30, the same way as they were inserted into the opening 24 along the insertion direction 30. Alternatively, the retention cap 1 can be secured to the front and form the mating face 64 itself. In that case, the internal components 16 need to be stacked from the front.

In order to prevent the ingress of water or other types of contaminants into the opening 24 of the housing 8, the housing assembly 2 may comprise a seal element 66. Depending on the number of cables 12 or wires 14, the seal element 66 may comprise suitable passage openings with inward sealing lips. Further, the seal element 66 may be configured to be at least partly arranged between the attachment collar 36 of the housing 8 and the abutment section 58 of the retention cap 1. For example, the seal element 66 may comprise a skirt 68 or a flange 70 that extends in the circumferential direction 34 radially outwards. This skirt 68 or flange 70 can be sandwiched and squeezed between the end face 56 of the attachment collar 36 and the stop surface 62 of the abutment section 58 (see FIG. 6).

To account for the lateral expansion of the squeezed seal element 66, the retention cap 1 may comprise a radial groove 72 extending in the circumferential direction 34 between the anchoring section 32 and the abutment section 58. The radial groove 72 may be part of the through hole 28. In particular, the through hole 28 may be widest at the radial groove 72. Hence, a displacement of the skirt 68 or flange 70 of the seal element 66 can be accommodated in the radial groove 72 when it is compressed and partially extruded from between the end face 56 and the stop surface 62 (see FIG. 6).

When the seal element 66 is present, the retention cap 1 may be supported by the seal element 66, which in turn is supported by the housing 8. In this position, the seal element 66 can compensate for any size tolerance. Further, the seal element 66 may also act as a damper that prevents relative movement between the retention cap 1 and the housing 8.

As can be seen in FIG. 11, the anchoring section 32 and the abutment section 58 may extend in a circumferentially closed manner. That is, the anchoring section 32 and the abutment section 58 may be continuous in the circumferential direction 34 without any gaps or breaks in their material. Further, the anchoring section 32 and the abutment section 58 may be mutually coaxial with respect to the insertion direction 30. Moreover, the anchoring section 32 and the abutment section 58 may be substantially cylindrical. That is, the anchoring section 32 and the abutment section 58 may have a round profile.

In order to prevent the retention cap 1 from freely rotating and rattling, at least one keying feature 74 may be provided on the retention cap 1. For example, the keying feature 74 may extend in the through hole 28 in the insertion direction 30. The housing 8, in turn, may comprises at least one complementary keying feature 74′ configured to be engaged with the at least one keying feature 74 of the retention cap 1. The keying features 74, 74′ may be pairs of key protrusions 76 and key ways 78 that are located at corresponding positions on the retention cap 1 and housing 8, in particular on the anchoring section 32 and the attachment collar 36.

As can be seen in FIG. 2, a material thickness 80 of the abutment section 58 may be larger than a material thickness 80 of the anchoring section 32. Hence, the anchoring section 32 may be less rigid, which facilitates the attachment of the retention cap 1 to the housing 8. Herein, the material thickness 80 of the respective sections may be an average material thickness measured in a radial direction 81 with respect to the insertion direction 30.

Optionally, the retention cap 1 may comprise an intermediate section 82 that connects the anchoring section 32 to the abutment section 58. The intermediate section 82 may extend around the through hole 28 in the circumferential direction 34. Further, the intermediate section 82 may have a smaller material thickness 80 than both, the anchoring section 32 and the abutment section 58. In particular, the above-mentioned radial groove 72 may be formed by the intermediate section 82.

As can be seen in FIG. 4, the abutment section 58, the anchoring section 32 and the intermediate section 82 may have less difference in the outer circumference 84 than in the inner circumference 60. Herein, the inner circumference 60 may be the length of the inner perimeter 86 or inner edge 88 of the respective section measured along the circumferential direction 34. In other words, the inner circumference 60 represents the boundary line 90 between the respective section and the through hole 28 in any given cross-section of the retention cap 1 perpendicular to the insertion direction 30. The smaller the inner circumference 60, the narrower the through hole 28. Consequently, the through hole 28 is narrower at the abutment section 58, than at the anchoring section 32.

Optionally, an outer surface 84 of the retention cap 1 may be provided with a knurling 94. That is, the retention cap 1 may comprise an outward facing knurled surface 96 located on the abutment section 58. A heat shrink tube (not shown) can be placed around the cables 12 or wires 14 and then be shrunk onto the knurled surface 96, if additional strain relief is required.

As can be seen in FIG. 10, the housing assembly 2 of the mating connector 10 may comprise a coupling ring 98. For example, the coupling ring 98 may be part of a bayonet-style mating aid mechanism that is shared between the connector 4 and the mating connector 10. As such, the coupling ring 98 may comprise at least one mating aid feature 100. The connector 4 may comprise at least one complementary mating aid feature 100′ configured to be engaged with the at least one mating aid feature 100 of the coupling ring 98.

In the shown embodiment, the at least one mating aid feature 100 is a cam groove 102, while the at least one complementary mating aid feature 100′ is a cam link 104 that is guided in the cam groove 104 when the coupling ring 98 is manually rotated. For improved stability, multiple pairs of such cam grooves 102 and cam links 104 can be provided in the connection assembly 6.

The coupling ring 98 may be held movably, in particular rotatably to the housing 8. For this purpose, the housing 8 of the housing assembly 2 may comprise a shoulder 106 adjacent to the attachment collar 36. When the retention cap 1 is secured to the attachment collar 36, the coupling ring 98 may be movably, in particular rotatably, held between the retention cap 1 and the shoulder 106. Optionally, a wave spring 108 may be provided between the coupling ring 98 and the shoulder 106, to prevent the coupling ring 98 from freely rotating and rattling.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Retention cap for maintaining structural integrity of a connector, the connector including a housing and at least one internal component inserted into an opening of the housing, the retention cap comprising:
an anchoring section for securing the retention cap to the housing around the opening;
an abutment section for retaining the at least one internal component inside the opening of the housing; and
a through hole for passing at least one cable or wire to the at least one internal component along an insertion direction;
wherein the anchoring section and the abutment section respectively extend around the through hole in a circumferential direction with respect to the insertion direction, and wherein the abutment section has a smaller inner circumference than the anchoring section.

2. Retention cap according to claim 1, wherein the abutment section comprises a stop surface facing towards the anchoring section, wherein the anchoring section comprises a latch surface facing towards the abutment section, wherein the stop surface and the latch surface are each perpendicular to the insertion direction and wherein, in a radial direction with respect to the insertion direction, the stop surface extends further than the latch surface.

3. Retention cap according to claim 1, wherein the anchoring section comprises a lead-in chamfer extending in the circumferential direction and obliquely to the insertion direction.

4. Retention cap according to claim 3, wherein the anchoring section comprises a centering surface extending in the circumferential direction and obliquely to the insertion direction at a different angle than the lead-in chamfer.

5. Retention cap according to claim 1, wherein the anchoring section and/or the abutment section extend in a circumferentially closed manner.

6. Retention cap according to claim 1, wherein a material thickness of the abutment section is larger than a material thickness of the anchoring section.

7. Retention cap according to claim 1, wherein the retention cap comprises a radial groove extending in the circumferential direction between the anchoring section and the abutment section.

8. Retention cap according to claim 1, wherein the retention cap comprises an outward facing knurled surface located on the anchoring section and/or the abutment section.

9. Housing assembly comprising:
a housing with an opening, wherein the housing includes an attachment collar extending in a circumferential direction around the opening; and
a retention cap coupled to the housing, the retention cap including an anchoring section for securing the retention cap to the housing around the opening, the retention cap including an abutment section for retaining the at least one internal component inside the opening of the housing, and the retention cap including a through hole for passing at least one cable or wire to the at least one internal component along an insertion direction, wherein the anchoring section and the abutment section respectively extend around the through hole in a circumferential direction with respect to the insertion direction, and wherein the abutment section has a smaller inner circumference than the anchoring section;
wherein the attachment collar is at least partly insertable into the through hole of the retention cap, and wherein the retention cap is configured to be secured to the attachment collar.

10. Housing assembly according to claim 9, wherein the attachment collar comprises an outwardly protruding bulge extending in the circumferential direction, wherein the anchoring section of the retention cap is configured to be secured to the bulge of the housing.

11. Housing assembly according to claim 9, wherein the retention cap comprises at least one keying feature extending in the insertion direction and wherein the housing comprises at least one complementary keying feature configured to be engaged with the at least one keying feature of the retention cap.

12. Housing assembly according to claim 9, wherein the housing assembly comprises a seal element, wherein the seal element is configured to be at least partly arranged between the attachment collar of the housing and the abutment section of the retention cap.

13. Connection assembly comprising:
a connector including a housing assembly and at least one internal component,
the housing assembly including a housing with an opening and a retention cap coupled to the housing, wherein the housing includes an attachment collar extending in a circumferential direction around the opening, the retention cap including an anchoring section for securing the retention cap to the housing around the opening, the retention cap including an abutment section and a through hole; and
the at least one internal component inserted into the opening of the housing, wherein the retention cap is secured to the attachment collar of the housing, and wherein the at least one internal component is retained inside the opening of the housing by the abutment section of the retention cap;
wherein the abutment section is configured for retaining the at least one internal component inside the opening of the housing;
wherein the through hole is configured for passing at least one cable or wire to the at least one internal component along an insertion direction, wherein the anchoring section and the abutment section respectively extend around the through hole in a circumferential direction with respect to the insertion direction, and wherein the abutment section has a smaller inner circumference than the anchoring section;
wherein the attachment collar is at least partly insertable into the through hole of the retention cap, and wherein the retention cap is configured to be secured to the attachment collar.

14. Connection assembly of claim 13, further comprising a mating connector that is configured to be pluggable with the connector.

15. Connection assembly according to claim 14, wherein the housing of the housing assembly comprises a shoulder adjacent to the attachment collar, wherein the housing assembly further comprises a coupling ring that is movably held between the retention cap and the shoulder, wherein the coupling ring comprises at least one mating aid feature, and wherein the mating connector comprises at least one complementary mating aid feature configured to be engaged with the at least one mating aid feature of the coupling ring.

16. Connection assembly of claim 13, wherein the attachment collar comprises an outwardly protruding bulge extending in the circumferential direction, wherein the anchoring section of the retention cap is configured to be secured to the bulge of the housing.

17. Connection assembly of claim 13, wherein the retention cap comprises at least one keying feature extending in the insertion direction and wherein the housing comprises at least one complementary keying feature configured to be engaged with the at least one keying feature of the retention cap.

18. Connection assembly of claim 13, wherein the housing assembly comprises a seal element, wherein the seal element is configured to be at least partly arranged between the attachment collar of the housing and the abutment section of the retention cap.

19. Connection assembly of claim 13, wherein the abutment section comprises a stop surface facing towards the anchoring section, wherein the anchoring section comprises a latch surface facing towards the abutment section, wherein the stop surface and the latch surface are each perpendicular to the insertion direction and wherein, in a radial direction with respect to the insertion direction, the stop surface extends further than the latch surface.

20. Connection assembly of claim 13, wherein the anchoring section comprises a lead-in chamfer extending in the circumferential direction and obliquely to the insertion direction.
